(19) United States
(12) Patent Application Publication
(10) Pub. No.: US 2015/0104686 A1
(43) Pub. Date: Apr. 16, 2015

(54) Battery and Cell Block for a Battery

(71) Applicant: Daimler AG, Stuttgart (DE)

(72) Inventors: Christian Brommer, Kirchheim (DE); Rainer Kaufmann, Stuttgart (DE); Jens Meintschel, Bernsdorf (DE); Dirk Schroeter, Winnenden (DE)

(73) Assignee: Daimler AG, Stuttgart (DE)

(21) Appl. No.: 14/363,128

(22) PCT Filed: Oct. 2, 2012
(86) PCT No.: PCT/EP2012/004135

§ 371 Date: Jun. 5, 2014

(30) Foreign Application Priority Data
Dec. 7, 2011 (DE) 10 2011 120511.3

(51) Int. Cl. H01M 2/10; H01M 10/6556; H01M 10/625; H01M 10/6572; H01M 10/647; H01M 2/20; H01M 10/04

(52) U.S. Cl. CPC H01M 2/1077; H01M 2/206; H01M 10/5057; H01M 10/0481; H01M 10/5085; H01M 10/5032; H01M 10/5016; H01M 2220/20
USPC 429/99

(57) ABSTRACT

A cell block for a battery includes a number of electrochemical single cells electrically connected to one another in series and/or in parallel. The single cells are flat cells oriented essentially in parallel and situated one behind the other in the cell block, and are tensioned with respect to one another by a tensioning element. The tensioning element is a temperature control plate for controlling the temperature of the single cells. The temperature control plate is situated on a longitudinal side of the cell block and thermally coupled to the single cells.

### BACKGROUND AND SUMMARY OF THE INVENTION

Exemplary embodiments of the present invention relate to a cell block for a battery and a battery.

Batteries for automotive applications are generally known from the prior art, in particular traction batteries for storing electrical energy for driving the vehicle. These batteries include a plurality of electrochemical single cells connected to one another in series and/or in parallel, which together with the associated electronics system and temperature control system are situated in a shared housing. For temperature control, the batteries in each case include, for example, at least one temperature control plate through which a fluid such water, refrigerant, or air directly flows, and which is thermally coupled to the single cells, directly or via a thermally conductive foil or casting compound.

The single cells are combined in so-called cell blocks, also referred to as cell assemblies, each of which has a certain number of single cells, including their mechanical fixing and electrical contacting. For rectangular single cells designed as flat cells, for example pouch cells or prismatic single cells, these single cells and their mounting, or the complete single cells for bipolar flat-frame cells, are pressed by pressure plates via tensioning means, thus forming a stable cell block. Tension rods or tightening straps, for example, are used as tensioning means for applying force to the pressure plates.

Exemplary embodiments of the present invention are directed to an improved cell block for a battery, and an improved battery.

A cell block for a battery includes a plurality of electrochemical single cells electrically connected to one another in series and/or in parallel, the single cells being flat cells oriented essentially in parallel and situated one behind the other in the cell block, and tensioned with respect to one another by means of at least one tensioning element.

Flat cells have two oppositely situated end faces that are significantly larger than circumferential edge surfaces. These types of flat cells are designed, for example, as so-called bipolar flat-frame cells, pouch cells, or coffee bag cells having a foil-like enclosure, or as prismatic flat cells.

The term “oriented essentially in parallel” means that the single cells are oriented parallel to one another within the scope of customary production and manufacturing tolerances.

According to the invention, the tensioning element is designed as a temperature control plate for controlling the temperature of the single cells, the temperature control plate being situated on a longitudinal side of the cell block and thermally coupled to the single cells.

As the result of the tensioning or pressing, which advantageously takes place mechanically by means of the temperature control plate, the single cells are fixed in the cell block in a force-fit and/or form-fit manner, and a stable cell block, also referred to as a cell assembly, is formed. Due to designing the tensioning element or at least one of multiple tensioning elements as a temperature control plate, a reduction in weight and cost of the cell block as well as a reduction in the installation space required for installing the cell block in a battery are achieved, since tensioning elements known from the prior art may be replaced by the temperature control plate, and the cell block therefore has a smaller design. That is, by using a component, namely, the temperature control plate, two functions may be met at the same time: tensioning the single cells to form a cell block, and controlling the temperature of the single cells, i.e., cooling and/or heating the single cells, in order to keep them at an optimal operating temperature or in an optimal operating temperature range. For this purpose, a temperature control medium such as air, water, or a refrigerant flows or may flow through the temperature control plate, and/or the temperature control plate is thermally coupled to a cold source and/or a heat source, for example at least one Peltier element or at least one heating unit designed as a so-called heating pad. The Peltier element or the heating pad is situated, for example, on a rear side of the temperature control plate facing away from the single cells.

The temperature control plate is thermally coupled to the single cells, either directly or, for example, via an electrically insulating thermally conductive foil or an electrically insulating casting compound with good thermal conductivity. In addition, tolerance compensation between the single cells and the temperature control plate is made possible via the thermally conductive foil or the casting compound, so that good, reliable thermal coupling of the temperature control plate to the single cells is ensured, even when tolerances occur. This type of electrically insulating thermally conductive foil or casting compound is necessary, for example, when the temperature control plate is thermally coupled to a housing of the single cells that is used as a pole contact and which is therefore electrically conductive, or to cell poles of the single cells, or to the single cells via cell connectors. Alternatively or additionally, for example thermal coupling of the temperature control plate to the single cells via cooling rods or cooling plates is possible if necessary, also using the thermally conductive foil or casting compound.

The temperature control plate is advantageously an integral part of a tensioning device, the tensioning device having two pressure plates, which in each case are situated on a transverse side of the cell block, i.e., on an end-face side of the cell block. In addition, the tensioning device has at least one connecting element for connecting at least one of the pressure plates to the temperature control plate. The temperature control plate is situated between the pressure plates in order to transmit a tensioning force or pressing force from one pressure plate to the other, i.e., from one side of the cell block to the other. The connecting element is designed in such a way that it allows a variable-length connection of the pressure plate to the temperature control plate, so that tolerances may be compensated for and a predefined tensioning or pressing may be set due to an increasing proximity of the pressure plate to the temperature control plate and a resulting increasing proximity of the two pressure plates to one another. The temperature control plate may be fixedly connected to one of the pressure plates, for example by an integrally bonded, form-fit, and/or force-fit connection, for example by welding or screwing. However, both pressure plates may also be connected to the temperature control plate by means of connecting elements, so that tensioning of the single cells is made possible due to increasing proximity of the two pressure plates to the temperature control plate by means of the connecting elements and a resulting increasing proximity of the two pressure plates to one another.

In one advantageous embodiment, the connecting element is designed as a screw for screwing at least one of the pressure plates to the temperature control plate. Of course, a plurality of such connecting elements, designed as screws, for example, is also possible. These screws are variable-length connecting elements, since they allow an increasing proximity of the pressure plate to the temperature control plate due to being progressively screwed into the temperature control plate. In an alternative embodiment, the connecting element may also be designed as a threaded rod, for example, which is fixedly situated in the temperature control plate. The pressure plate may then be pushed onto the threaded rod and screwed to the temperature control plate by means of a screw nut to be threaded onto the threaded rod, as the result of which the pressure plate comes increasingly closer to the temperature control plate, and the pressure plates come increasingly closer to one another with increasing tensioning of the single cells situated in between.

The single cells advantageously have frame elements on the edge side, or are enclosed, at least in part, by frame elements on the edge side in the cell block, the maximum length of the temperature control plate being equal to the combined length of all frame elements of the cell block, which are oriented in parallel and situated one behind the other. Fixed tensioning of the single cells with the pressure plates all the way against the temperature control plate is ensured in this way. To also ensure this for width tolerances of the frame elements, it is advantageous for the temperature control plate to be slightly shorter, so that the single cells are still adequately tensioned by the pressure plates, even for a slightly thinner design of some of the frame elements.

In one advantageous embodiment, the cell block has two temperature control plates situated at opposite longitudinal sides of the cell block. All tensioning means known from the prior art may thus be replaced by the temperature control plates; i.e., the cell block is securely tensioned solely by means of the temperature control plates, the pressure plates, and the connecting elements, so that no further tensioning elements that would entail additional weight, additional costs, and additional installation space requirements are necessary. In addition, the temperature control of the single cells is optimized in this way, since the single cells are to be temperature-controlled from two opposite sides over their entire extent in a relatively uniform and reliable manner. Of course, it is also possible for a temperature control plate to be situated in each case on three longitudinal sides or on all four longitudinal sides of the cell block. The temperature control as well as the tensioning of the single cells may thus be further improved if necessary. Furthermore, some other arrangement of two temperature control plates on the cell block is of course possible, i.e., not on opposite longitudinal sides, but on mutually adjoining longitudinal sides.

In one advantageous embodiment, the cell block includes at least one additional tensioning element for tensioning, in particular for mechanically tensioning, the single cells. This is advantageous in particular when only one temperature control plate is situated on the cell block and used as a tensioning element. In this case, to ensure proper tensioning, tensioning, which is achievable by means of one or more additional tensioning elements, is likewise necessary in the area of the oppositely situated longitudinal side.

The additional tensioning element is preferably designed as a tension rod or as a tightening strap. A tightening strap surrounds the entire cell block, including the two pressure plates, in the longitudinal direction, the single cells being tensioned and pressed by stretching the tightening strap. A tension rod is guided along the cell block from one pressure plate to the other in the longitudinal direction of the cell block, and passes through the pressure plates. The tension rod is designed as a threaded rod, for example, which has a thread on one or both ends, so that the pressure plates may be tensioned against one another by threading screw nuts onto the thread. If the tension rod has such a thread only on one end, at the other end it is fastened in a different way to the particular pressure plate in an integrally bonded, form-fit, and/or force-fit manner, for example by welding.

A battery according to the invention includes at least one cell block of this type. Due to designing the tensioning element or at least one of multiple tensioning elements as a temperature control plate, a reduction in weight and cost of the cell block, and thus also of the battery, as well as a reduction in the installation space required for installing the cell block in the battery are achieved, since tensioning elements known from the prior art may be replaced by the temperature control plate, and the cell block therefore has a smaller design. That is, by using a component, namely, the temperature control plate, two functions may be met at the same time: tensioning the single cells to form a cell block, and controlling the temperature of the single cells, i.e., cooling and/or heating the single cells, in order to keep them at an optimal operating temperature or in an optimal operating temperature range. Due to the smaller required installation space for the cell block in the battery, the battery also has a smaller design, so that the battery as well requires a smaller installation space in a vehicle, for example.

The battery preferably includes a plurality of cell blocks electrically connected to one another in series and/or in parallel. In this way a battery is formed having a voltage, current intensity, and storage capacity necessary for a particular purpose.

The battery is advantageously a vehicle battery, in particular a traction battery for an electric vehicle, for a vehicle having a hybrid drive, or for a fuel cell vehicle. This type of traction battery is used as an energy store for electrical energy for driving the vehicle. In particular due to the smaller design of the cell block, and thus of the battery having one or more of these cell blocks, which is made possible, a reduction in installation space and weight is achieved which is of great importance in particular for use as a traction battery in an electric vehicle, in a vehicle having a hybrid drive, or in a fuel cell vehicle, in which only limited installation space is available for the battery or a plurality of such batteries. Due to the reduction in installation space, additional batteries of this type may be used, thus increasing the range of the vehicle, for example, or for with the number of batteries remaining the same, more space is available in the vehicle for passengers and luggage. Furthermore, the weight reduction achieved results in lower energy consumption of the vehicle due to the lower weight, so that the range of the vehicle is increased, and in addition a higher potential load capacity of the vehicle is achieved due to a lower empty weight. Due to the achieved reduction in cost of the cell block and the battery, a cost reduction for the vehicle is also achieved for this type of use as a vehicle battery.

### BRIEF DESCRIPTION OF THE DRAWING FIGURES

Exemplary embodiments of the invention are explained below in greater detail with reference to the drawings, which show the following:

FIG. 1 schematically shows a partially exploded illustration of a first embodiment of a cell block,

FIG. 2 schematically shows a perspective illustration of a first embodiment of a cell block,

FIG. 3 schematically shows a longitudinal sectional illustration of a first embodiment of a cell block,

FIG. 4 schematically shows a cross-sectional illustration of a first embodiment of a cell block,

FIG. 5 schematically shows a partially exploded illustration of a second embodiment of a cell block,

FIG. 6 schematically shows a perspective illustration of a second embodiment of a cell block,

FIG. 7 schematically shows a longitudinal sectional illustration of a second embodiment of a cell block,

FIG. 8 schematically shows a partially exploded illustration of a third embodiment of a cell block,

FIG. 9 schematically shows a perspective illustration of a third embodiment of a cell block,

FIG. 10 schematically shows a longitudinal sectional illustration of a third embodiment of a cell block, and

FIG. 11 schematically shows a battery.

Mutually corresponding parts are provided with the same reference numerals in all figures.

### DETAILED DESCRIPTION

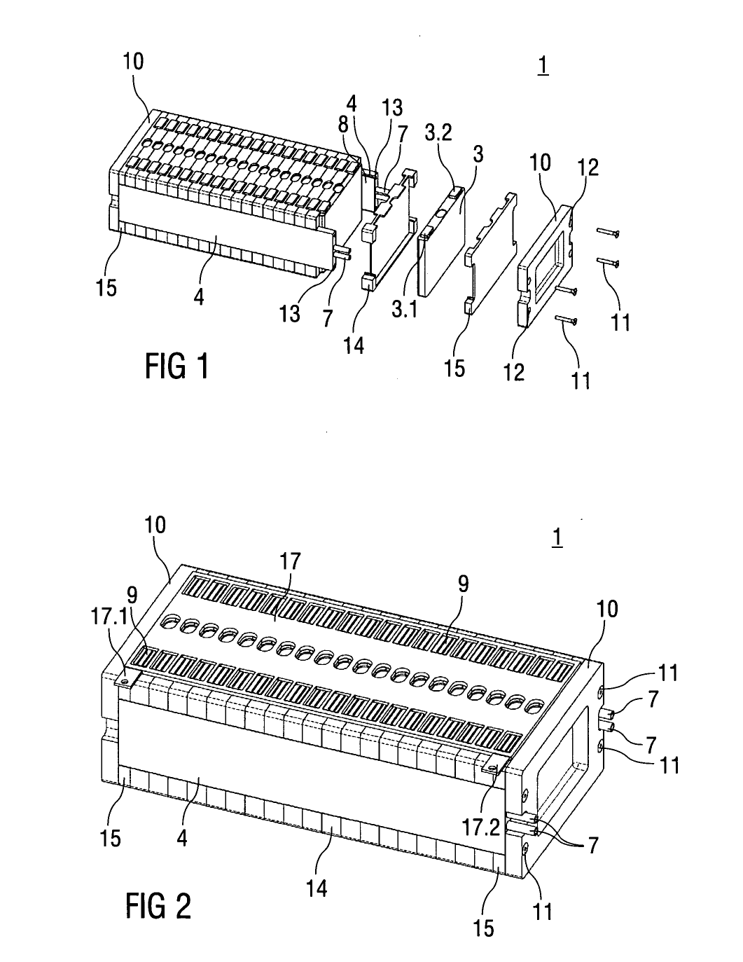

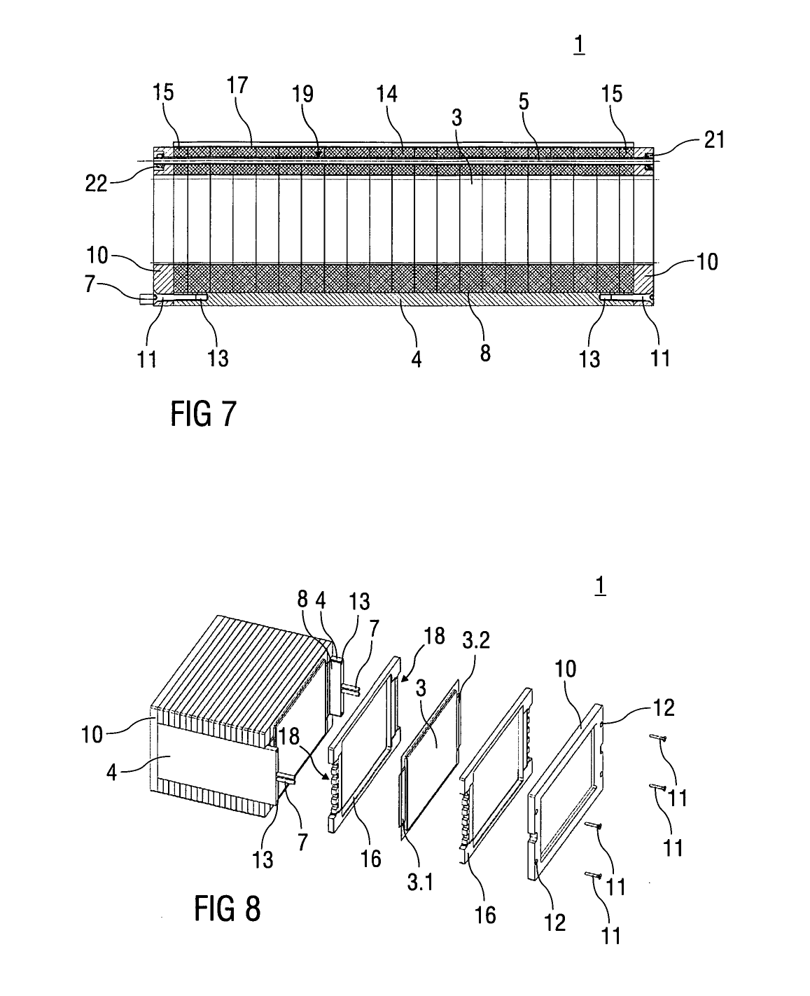

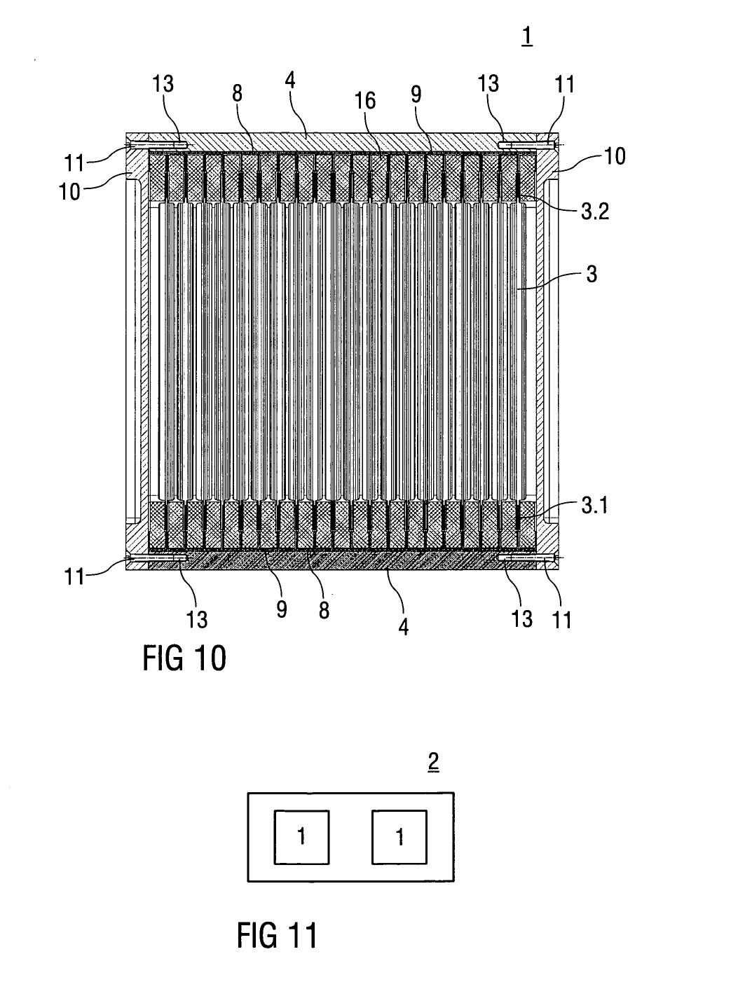

FIGS. 1 through 10 show three different embodiments of a cell block 1 for a battery 2, each in various schematic illustrations. A cell block 1 of this type is also referred to as a cell assembly. FIG. 11 shows a battery 2 having a plurality of such cell blocks 1 electrically connected to one another in series and/or in parallel.

The cell block 1 in each case has a plurality of electrochemical single cells 3 electrically connected to one another in series and/or in parallel, which are designed as flat cells, and which are oriented essentially in parallel and situated one behind the other in the cell block 1. The single cells 3, designed as flat cells, in each case have two oppositely situated end faces which are significantly larger than circumferential edge surfaces.

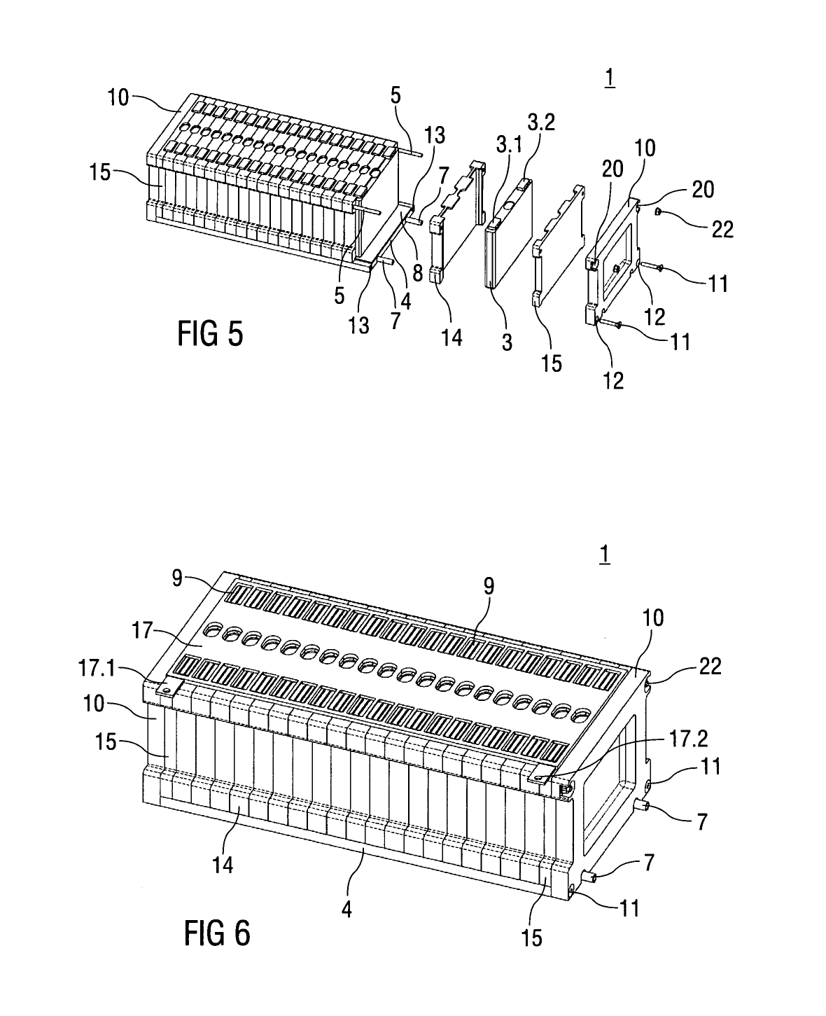

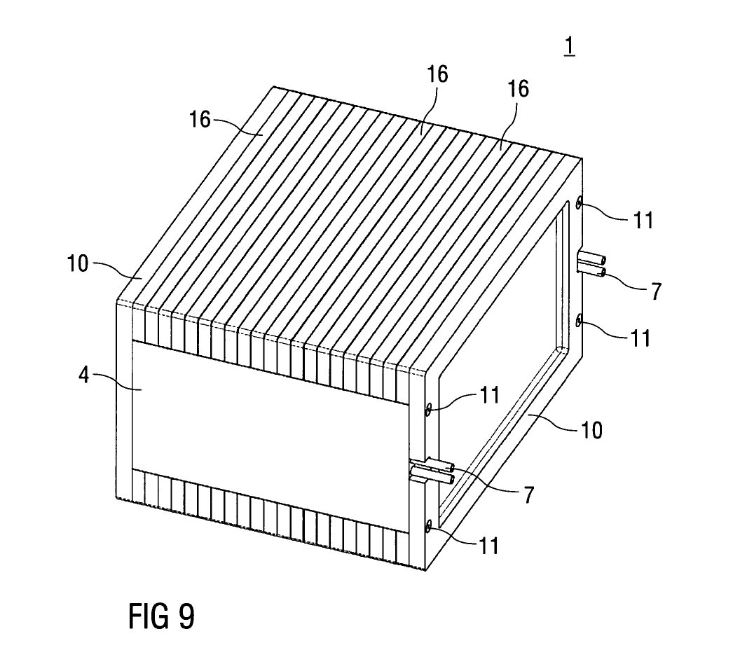

In the first exemplary embodiment illustrated in FIGS. 1 through 4 and in the second exemplary embodiment illustrated in FIGS. 5 through 7, the single cells 3 are designed as prismatic flat cells which have a metallic cell housing, whereby cell poles 3.1, 3.2 of the particular single cell 3, i.e., one electrically positive pole and one electrically negative pole, are situated at an upper longitudinal side of the single cell 3. In the third exemplary embodiment illustrated in FIGS. 8 through 10, the single cells 3 are designed as so-called pouch cells in which an electrochemically active electrode foil unit and electrolyte are surrounded by a foil-like enclosure that is welded on the edge side, and cell poles 3.1, 3.2 designed as discharge tabs in the form of metal sheets are led out from the enclosure. In addition, so-called bipolar flat-frame cells, not illustrated in greater detail here, in which a frame is integrated into the single cell 3 and which have two electrically conductive metallic enveloping sheets, each designed as a cell pole 3.1, 3.2 of the single cell 3, are also possible as flat cells.

The single cells 3 are tensioned against one another or pressed together by means of tensioning elements in order to fix the single cells 3 in the cell block 1 in a force-fit and/or form-fit manner and to form a stable cell block 1. In the first exemplary embodiment illustrated in FIGS. 1 through 4 and in the third exemplary embodiment illustrated in FIGS. 8 through 10, all tensioning elements are designed as temperature control plates 4 for controlling the temperature of the single cells 3, and which are situated at opposite longitudinal sides of the cell block 1 and thermally coupled to the single cells 3. The second exemplary embodiment illustrated in FIGS. 5 through 7 has only one tensioning element of this type designed as a temperature control plate 4, so that additional tensioning elements 5, which are not designed as a temperature control plate 4, are necessary to ensure proper tensioning of the single cells 3. These additional tensioning elements 5 are situated in the area of a longitudinal side of the cell block 1 opposite from the temperature control plate 4, and in the second exemplary embodiment, are situated in the area of a top side of the cell block 1.

In addition to the function as a tensioning element for tensioning and pressing the single cells 3 to form a cell block 1, the temperature control plates 4 are used for controlling the temperature of the single cells 3, i.e., cooling and/or heating the single cells 3, in order to keep them at an optimal operating temperature or in an optimal operating temperature range. For this purpose, channels 6 pass through the temperature control plates 4 illustrated in the exemplary embodiments, and a temperature control medium such as air, water, or a refrigerant flows or may flow through the temperature control plates. For this purpose, the temperature control plates have two connecting elements 7 via which the particular temperature control plate 4 is to be coupled to a temperature control circuit, for example an air conditioning circuit or a cooling circuit of a vehicle. Alternatively or additionally, in further embodiments not illustrated here, the particular temperature control plate 4 may be thermally coupled, for example, to a cold source and/or a heat source, for example having at least one Peltier element or at least one heating unit designed as a so-called heating pad. The Peltier element or the heating pad is situated, for example, on a rear side of the temperature control plate 4 facing away from the single cells 3.

The temperature control plates 4 are thermally coupled to the single cells 3, either directly in each case or, as in the embodiments illustrated here, in each case via an electrically insulating thermally conductive foil 8 situated between the single cells 3 and the temperature control plate 4. As an alternative to the thermally conductive foil 8, an electrically insulating casting compound, not illustrated here, having good thermal conductivity is possible between the single cells 3 and the particular temperature control plate 4.

The particular temperature control plate 4 is electrically insulated from the single cells 3 by means of the thermally conductive foil 8 or the casting compound. In addition, tolerance compensation between the single cells 3 and the particular temperature control plate 4 is thus made possible, so that good, reliable thermal coupling of the temperature control plate 4 to the single cells 3 is ensured, even when tolerances occur.

Due to the electrically insulating thermally conductive foil 8, or in the examples not illustrated here, the casting compound, it is possible to thermally couple the temperature control plate 4 to a metallic electrically conductive housing of the single cells 3, as illustrated in FIGS. 1 through 7 in the first and second exemplary embodiments with reference to the single cells 3 designed as prismatic flat cells having this type of metallic housing. Due to the arrangement of the particular electrically insulating thermally conductive foil 8 between the single cells 3 and the particular temperature control plate 4, the temperature control plate 4 is electrically insulated from the single cells 3, but is thermally coupled very well to the single cells 3 due to the very good thermal conductivity of the thermally conductive foil 8.

In the third exemplary embodiment illustrated in FIGS. 8 through 10, the two temperature control plates 4 are thermally coupled to cell poles 3.1, 3.2 of the single cells 3, designed as discharge tabs, via cell connectors 9. The cell poles 3.1, 3.2, which are designed as discharge tabs, are connected to the U-shaped metallic cell connectors 9 in an integrally bonded manner, for example by ultrasonic welding or resistance pressure welding, so that the temperature control plates 4 are thermally coupled via the cell connectors 9 and the cell poles 3.1, 3.2 designed as discharge tabs to a cell interior of the single cells 3 designed as pouch cells, i.e., to the electrode film unit and the electrolyte. Here as well, in each case a thermally conductive foil 8 is situated between the particular temperature control plate 4 and the single cells 3 or the cell connectors 9 for electrically insulating the temperature control plates 4 from the cell connectors 9.

Additionally or alternatively, in further embodiments not illustrated here, for example thermal coupling of the particular temperature control plate 4 to the single cells 3 via cooling rods or cooling plates is possible if necessary, also using the thermally conductive foil 8 or casting compound.

To allow the proper tensioning of the single cells 3 in the cell block 1, the temperature control plates 4 are each an integral part of a tensioning device. This type of tensioning device has two pressure plates 10 which in each case are situated on a transverse side of the cell block, i.e., on an end-face side of the cell block 1. In addition, the tensioning device has connecting elements 11 for connecting the pressure plates 10 to the particular temperature control plate 4. The temperature control plates 4 are each situated between the pressure plates 10 in order to transmit a tensioning force or pressing force from one pressure plate 10 to the other, i.e., from one side of the cell block 1 to the other. The connecting elements 11 are designed in such a way that they allow a variable-length connection of the pressure plates 10 to the temperature control plate 4, so that tolerances may be compensated for and a predefined tensioning or pressing may be set due to an increasing proximity of the pressure plates 10 to the particular temperature control plate 4 and a resulting increasing proximity of the two pressure plates 10 to one another.

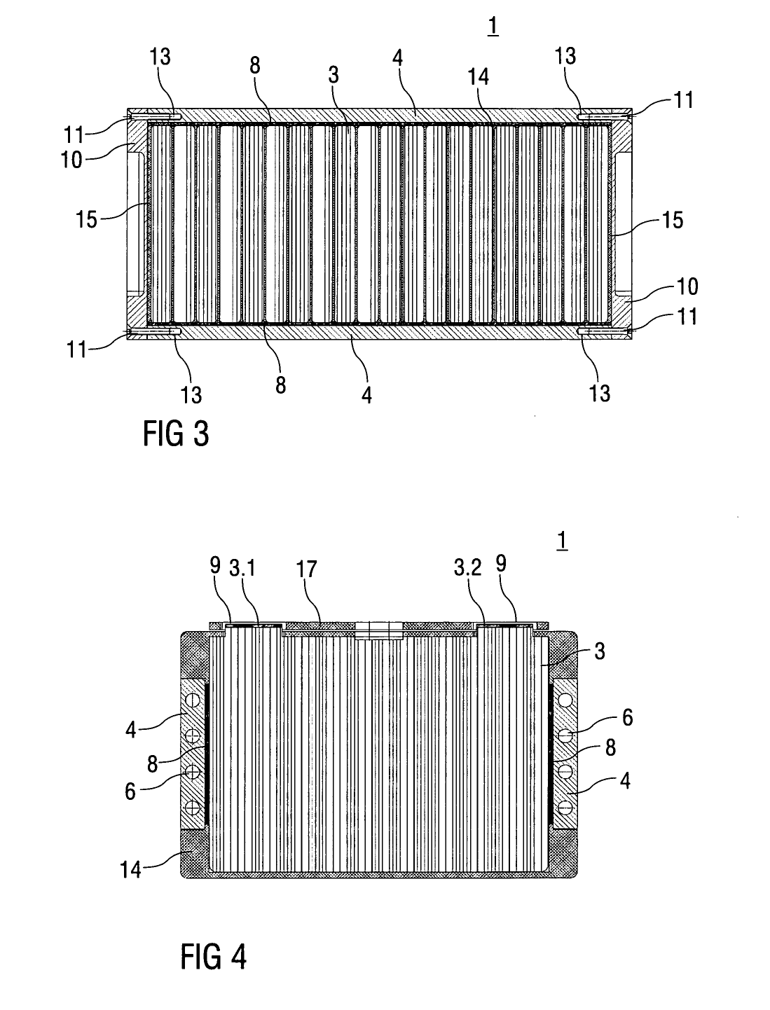

As illustrated here, the connecting elements 11 are designed, for example, as screws for screwing the pressure plates 10 to the temperature control plates 4, and which are each passed through an opening 12 in the particular pressure plate 10 and screwed into the particular temperature control plate 4, a screw head remaining in the area of a side of the particular pressure plate 10 facing away from the temperature control plate 4, so that, due to screwing into the temperature control plate 4, the pressure plate 10 is pulled against the temperature control plate 4 by means of the screw. These screws are variable-length connecting elements 11, since they allow an increasing proximity of the particular pressure plate 10 to the temperature control plate 4 due to being progressively screwed into the temperature control plate 4. To ensure this, as illustrated in particular in FIGS. 3, 7, and 10, threaded holes 13 which are at least as deep as a maximum possible thread reach of the connecting elements 11 designed as screws are necessary in the temperature control plates 4.

In an alternative embodiment not illustrated here, the connecting elements 11 may also be designed as threaded rods, for example, which are fixedly mounted in the temperature control plate 4. The pressure plates 10 may then be pushed onto the threaded rods, whereby the threaded rods are to be guided through the openings 12 in the pressure plates 10 and screwed to the temperature control plate 4 by means of nuts which are to be threaded onto the threaded rods, as the result of which the pressure plates come increasingly closer to the temperature control plate 4, and the pressure plates 10 come increasingly closer to one another with increasing tensioning of the single cells 3 situated in between.

In another exemplary embodiment not illustrated here, the particular temperature control plate 4 may also be fixedly connected to one of the pressure plates 10, for example by an integrally bonded, form-fit, and/or force-fit connection, for example by welding or screwing, so that the single cells 3 are tensioned in the cell block 1 by progressively screwing the respective other pressure plate 10 to the particular temperature control plate 4.

In the exemplary embodiments illustrated here, the single cells 3 in the cell block 1 are enclosed, at least in part, by frame elements 14, 15, 16 on the edge side. In other exemplary embodiments not illustrated here, in which the cell block 1 is formed, for example, by single cells 3 designed as bipolar flat-frame cells, these types of frame-side frame elements 14, 15, 16 are an integral part of the single cells 3.

In the first and second exemplary embodiments illustrated in FIGS. 1 through 7, first and second frame elements 14, 15 as spacers made of plastic are situated between the single cells 3 or between the single cells 3 of the cell block 1 on the end-face side and the particular pressure plate 10, and in each case have frame areas on the edge side and a middle area which covers a respective end-face side of the single cell 3. The single cells 3 are held at a defined distance from one another and electrically insulated with respect to one another by the first frame elements 14. A second frame element 15 on which the edge-side frame areas are formed only in the direction of the respective single cell 3 on the end-face side is situated in each case between the single cells 3 of the cell block 1 on the end-face side and the particular pressure plate 10. At the upper longitudinal side of the cell block 1, the edge-side frame areas of the particular frame element 14, 15 are separated at a distance from one another such that the cell poles 3.1, 3.2 may be passed between same.

In this example, the single cells 3 are electrically connected to one another in series by means of cell connectors 9 situated on the cell poles 3.1, 3.2, but in other exemplary embodiments may also be connected to one another in parallel, or the cell block 1 may have a combination of single cells 3 which are electrically connected to one another in series and electrically connected to one another in parallel. The cell connectors 9, which are combined in a cell connector plate 17, are connected to the cell poles 3.1, 3.2 by lap laser welding, for example. The cell connector plate 17 has two cell block poles 17.1, 17.2 via which the cell block 1 is electrically contactable.

In the third exemplary embodiment illustrated in FIGS. 8 through 10, the single cells 3, designed as pouch cells, are fixed in the cell block 1 and held at a defined distance from one another by third frame elements 16. That is, in the middle the third frame elements 16 each have a formation enclosed on the edge side by the frame area, and in which the particular single cell 3 is situated. Each of the single cells 3 is clamped between two such third frame elements 16, which in each case rest against an end-face side of the particular single cell 3 on the edge side. Due to a pressing force that is generated by the tensioning of the cell block 1, the single cells 3 are fixedly clamped between the third frame elements 16, and are held in the cell block 1 in a force-fit and/or form-fit manner.

The cell poles 3.1, 3.2, which are designed as discharge tabs, of adjoining single cells 3 are electrically contacted to one another by means of U-shaped metallic cell connectors 9 that are fastened to the third frame elements 16. For this purpose, the cell poles 3.1, 3.2 are fastened to the cell connectors 9 by ultrasonic welding or resistance pressure welding, for example. To allow this, the third frame elements 16 have cell connector areas 18 at two opposite sides, on which a cell connector 9 is to be mounted in each case. The cell connectors 9 and the cell connector areas 18 of the third frame elements 16 each have cutouts. These cutouts are used to accommodate a correspondingly shaped tool which is used as an abutment during the ultrasonic welding for contacting the particular cell pole 3.1, 3.2 to the respective cell connector 9. It is thus possible for the particular cell pole 3.1, 3.2 and the respective cell connector 9 to be pressed against one another with an appropriate force during the welding, so that a flat support is ensured and the established connection has good electrical conductivity.

In all illustrated embodiments, in each case the maximum length of the temperature control plates 4 is equal to the combined length of all frame elements 14, 15, 16 of the particular cell block 1, which are oriented in parallel and situated one behind the other. Fixed tensioning of the single cells 3 with the pressure plates 10 all the way against the particular temperature control plate 4 is ensured in this way. To ensure this also for width tolerances of the frame elements 14, 15, 16, it is advantageous for the temperature control plates 4 to be slightly shorter, so that the single cells 3 are still adequately tensioned by the pressure plates 10, even for a slightly thinner design of some of the frame elements 14, 15, 16.

In the first and third exemplary embodiments, in which the cell block 1 in each case has two temperature control plates 4 that are situated on opposite longitudinal sides of the cell block 1, the tensioning device includes only these two temperature control plates 4, the two pressure plates 10, and the connecting elements 11, since proper tensioning of the single cells 3 is already made possible by means of the two temperature control plates 4. That is, no additional tensioning elements 5 are necessary.

In the second exemplary embodiment illustrated in FIGS. 5 through 7, in which the cell block 1 has only one temperature control plate 4, additional tensioning elements 5 are necessary for proper tensioning of the single cells 3 in the cell block 1; i.e., in this exemplary embodiment, in addition to the temperature control plate 4, the pressure plates 10, and the connecting elements 11, the tensioning device includes the additional tensioning elements 5. As described above, in the present case the temperature control plate 4 is situated on a lower longitudinal side of the cell block 1, and the additional tensioning elements 5 are situated in the area of a longitudinal side of the cell block 1 opposite from the temperature control plate 4, i.e., in the example illustrated here, in the area of an upper longitudinal side of the cell block 1.

In the second exemplary embodiment illustrated here, these additional tensioning elements 5 are designed as tension rods. However, in alternative embodiments not illustrated here, the additional tensioning elements 5 may also be designed as tightening straps, for example, which surround the entire cell block 1, including the two pressure plates 10, in the longitudinal direction, the single cells 3 being tensioned and pressed by stretching the tightening straps.

The additional tensioning elements 5, designed as tension rods, which are used in the illustrated exemplary embodiment are situated in corner areas of the upper longitudinal side of the cell block 1, along the cell block 1 from one pressure plate 10 to the other in the longitudinal direction of the cell block. The additional tensioning elements are guided through boreholes 19 in the first and second frame elements 14, 15 enclosing the single cells 3, and through additional openings 20 in one of the pressure plates 10, and are fastened in the other pressure plate 10 in an integrally bonded, form-fit, and/or force-fit manner, for example, as illustrated here, screwed into threaded elements 21 situated in the other pressure plate 10. The additional tensioning elements 5 designed as tension rods are formed, at least in part, as threaded rods; i.e., they have a thread at each end. In this way they are to be screwed at one end into the respective threaded element 21 of one pressure plate 10, and in each case a screw nut 22 is to be threaded onto the other end which is guided through the other pressure plate 10, so that the pressure plates 10 are tensioned against one another by progressively threading the screw nuts 22 onto the thread of the respective additional tensioning element 5 designed as a tension rod.

The battery 2 illustrated in FIG. 11 includes a plurality of cell blocks 1 of this type which are electrically connected to one another in series and/or in parallel. In this way a battery 2 is formed which has a voltage, current intensity, and storage capacity necessary for a particular purpose.

By designing the tensioning elements or at least one of the tensioning elements as a temperature control plate 4, a reduction in weight and cost of the cell block 1, and thus of the battery 2, as well as a reduction in the installation space required for installing the cell block 1 in the battery 2 are achieved, since tensioning elements known from the prior art may be replaced by the temperature control plate 4 or by the plurality of temperature control plate plates 4, and the cell block 1 therefore has a smaller design. That is, by using a component, namely, the temperature control plate 4, two functions may be met at the same time: tensioning the single cells 3 to form a cell block 1, and controlling the temperature of the single cells 3, i.e., cooling and/or heating the single cells 3, in order to keep them at an optimal operating temperature or in an optimal operating temperature range. Due to the smaller required installation space for the cell block 1 in the battery 2, the battery 2 also has a smaller design, so that the battery 2 as well requires a smaller installation space in a vehicle, for example.

The battery 2 is, for example, a vehicle battery, in particular a traction battery for an electric vehicle, for a vehicle having a hybrid drive, or for a fuel cell vehicle. This type of traction battery is used as an energy store for electrical energy for driving the vehicle.

In particular due to the smaller design of the cell block 1 having one or more of these cell blocks 1, and thus of the battery 2, which is made possible, a reduction in installation space and weight is achieved, which is of great importance in particular for use as a traction battery in an electric vehicle, in a vehicle having a hybrid drive, or in a fuel cell vehicle, in which only limited installation space is available for the battery 2 or a plurality of such batteries 2. Due to the reduction in installation space, additional batteries of this type may be used, thus increasing the range of the vehicle, for example, or for with the number of batteries remaining the same, more space is available in the vehicle for passengers and luggage. Furthermore, the weight reduction achieved results in lower energy consumption of the vehicle due to the lower weight, so that the range of the vehicle is increased, and in addition a higher potential load capacity of the vehicle is achieved due to a lower empty weight. Due to the achieved reduction in cost of the cell block 1 and the battery 2, a cost reduction for the vehicle is also achieved in this type of use as a vehicle battery.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

### LIST OF REFERENCE NUMERALS

1 Cell block
2 Battery
3 Single cell
3.1, 3.2 Cell pole
4 Temperature control plate
5 Additional tensioning element
6 Channel
7 Connecting element
8 Thermally conductive foil
9 Cell connector
10 Pressure plate
11 Connecting element
12 Opening
13 Threaded hole
14 First frame element
15 Second frame element
16 Third frame element
17 Cell connector plate
17.1, 17.2 Cell block pole
18 Cell connector area
19 Borehole
20 Additional opening
21 Threaded element
22 Screw nut

1-10. (canceled)

11. A cell block for a battery, comprising:
a plurality of electrochemical single cells electrically connected to one another in series or in parallel, wherein each of the plurality of electromechanical cells are flat cells oriented essentially in parallel and situated one behind the other in the cell block;
a tensioning element configured to tension the plurality of electromechanical single cells with respect to one another, wherein the tensioning element is a temperature control plate configured to control a temperature of the plurality of electromechanical single cells, wherein the temperature control plate is arranged on a longitudinal side of the cell block and thermally coupled to the plurality of electromechanical single cells.

12. The cell block of claim 11, wherein the temperature control plate is an integral part of a tensioning device comprising
two pressure plates arranged on opposite transverse sides of the cell block; and
at least one connecting element arranged to connect at least one of the two pressure plates to the temperature control plate.

13. The cell block of claim 12, wherein the connecting element is a screw configured to screw at least one of the two pressure plates to the temperature control plate.

14. The cell block of claim 11, wherein each of the plurality of electromechanical single cells has frame elements on an edge side, or are enclosed, at least in part, by frame elements on the edge side in the cell block, wherein a maximum length of the temperature control plate is equal to a combined length of all frame elements of the cell block, which are oriented in parallel and situated one behind another.

15. The cell block of claim 11, wherein the temperature control plate comprises two temperature control plates arranged at opposite longitudinal sides of the cell block.

16. The cell block of claim 11, further comprising:
at least one additional tensioning element configured to tension the plurality of electromechanical single cells.

17. The cell block of claim 16, wherein the at least one additional tensioning element is a tension rod or a tightening strap.

18. A battery, comprising:
at least one cell block, which comprises
a plurality of electrochemical single cells electrically connected to one another in series or in parallel, wherein each of the plurality of electromechanical cells are flat cells oriented essentially in parallel and situated one behind the other in the cell block;
a tensioning element configured to tension the plurality of electromechanical single cells with respect to one another, wherein the tensioning element is a temperature control plate configured to control a temperature of the plurality of electromechanical single cells, wherein the temperature control plate is arranged on a longitudinal side of the cell block and thermally coupled to the plurality of electromechanical single cells.

19. The battery of claim 18, wherein the at least one cell block comprises a plurality of cell blocks electrically connected to one another in series or in parallel.

20. The battery of claim 18, wherein the battery is a traction battery for an electric vehicle, for a vehicle having a hybrid drive, or for a fuel cell vehicle.
